(19) United States
(12) Patent Application Publication
(10) Pub. No.: US 2007/0067419 A1
(43) Pub. Date: Mar. 22, 2007

(54) Dedicated client devices supporting web based service, specifications and interaction

(76) Inventor: James D. Bennett, San Clemente, CA (US)

Correspondence Address: GARLICK HARRISON & MARKISON, P.O. BOX 160727, AUSTIN, TX, 78716-0727, US

(21) Appl. No.: 11/230,086

(22) Filed: Sep. 19, 2005

(51) Int. Cl. G06F 15/16

(52) U.S. Cl. 709/219

(57) ABSTRACT

A product support network that facilitates web based service, specifications and interaction includes a dedicated client device adapted to provide web pages to an interrogating machine such as a personal computer using a web browser. A plurality of support servers support testing and upgrading of the dedicated client devices, underlying components and peripherals, delivering manuals and user guides, and gathering usage statistics. Some interaction between the dedicated client device and the server does not require the personal computer. The dedicated client device circuitry consists of a system controller, a memory, a communication interface, a user input device and a display. The dedicated client device is capable of establishing communication and interacting with the server directly, being facilitated by a user input device and a display. The device related web page stored in the memory of dedicated client device includes manufacturers information related to program code, chip sets, peripherals and the device itself as well as the present working status of the device.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

1. Field of the Invention

This invention relates generally to the servicing, maintenance and registration of devices with electronic functionality, more particularly, to techniques for providing support for dedicated client devices.

2. Related Art

Today, a wide variety of dedicated client devices are commercially available for daily use within homes, offices, and the outdoors. Examples of such dedicated devices include digital cameras, cell phones, high definition digital televisions, digital radios, media players, digital toys, video games, and camcorders. Other dedicated client devices include household appliances such as refrigerators, washing machines, air conditioners and ovens use digital electronic circuitry which facilitates ease of use. Still other dedicated client devices provide specific functionality to end users.

These dedicated client devices often times appear to have failed. In such cases, users of the dedicated client devices may conclude that the devices require the attention of trained service personnel. Because of their size or their fixed installation, some dedicated client devices such as heating units, dishwashers, air-conditioners, and washing machines are not typically taken to service centers. Service is usually provided on site and at high cost. Many times, service personnel conclude that the user mistakenly requested service and finds that the dedicated client device was simply being used incorrectly. Many other times, service personnel have to return to their work facilities once or more to order or retrieve parts or manuals and return to complete the servicing. Often, users find that it would have been cheaper to have replaced their dedicated client device with a new one.

Users of some dedicated client devices that are mistakenly believed to not function properly are taken to a service center, either directly or via the place of purchase. These services often cause unacceptable, long delays in service and user inconvenience in having to travel to and interact with service center. As before, users often choose to purchase a new replacement instead.

Call centers have been set up by many manufacturers in attempts to troubleshoot the users' claimed defective operation of the dedicated client devices. Often, service personnel working in the call centers are faced with a user's inadequate description of the problems and inadequate skills in carrying out instructions. These factors often prevent adequate evaluation of the user's claims, prevent or cause delays in servicing, and increase service costs.

Peripherals used with some dedicated client devices, e.g., rechargeable batteries, power adapters, and expanded memory cards, often break down and require replacement. It is quite typical for a user to conclude that the dedicated client device is malfunctioning when the problem may have been with the peripheral. Users that are unaware of such peripheral problems often throw away the dedicated client device, even though replacement of a relatively much less expensive peripheral would have fully resolved the perceived problem with the dedicated client device.

Even though users may be able to correctly identify a dedicated client device defect or peripheral defect, they may not know where to purchase replacement parts or where to seek service assistance. In some cases, spare parts and peripherals are not available because the devices are old. The manufacturer may offer alternative solutions of which the users are never aware. As a result, users again typically seek to purchase new devices rather than face the difficulties of getting necessary the information and follow up the procedures.

The program code (software or firmware) used in many dedicated client devices is upgraded periodically as the device manufacturer, chipset vendor or software provider releases newer and more versatile versions of program code. Typically, newer versions are released in order to address problems that were undetected before product release as well as adding additional functionality. Users who determine that new program code release exists often must contact the service centers or visit the manufacturers, vendors, or place of purchase to get their devices upgraded. Similarly, in order to test and upgrade newer versions of peripherals, the users must contact the manufacturers or vendors or place of purchase, or visit them personally.

The manufacturers, chipset vendors, or software providers provide users with manuals, user guides, or operating guides in order to instruct the user how to operate the dedicated client devices. Users typically want to access manuals during setup and later to alter original settings, explore device functionality, troubleshoot problems, identify available peripherals and identify manufacturer's contact information. Many times these manuals are not received by the users. Because the manual is typically in a paper form and disassociated with the dedicated client device, it is often misplaced. The upgraded or serviced products require newly released manuals which are often unavailable to the users.

The manufacturers, vendors and providers of the chipsets, components, peripherals and program code found inside these devices have service and warranty obligations, for which the users contact them periodically. The respective manufacturers and vendors use statistics and other information about the state of the devices, components, peripherals and program code in order to fulfill their service and contract obligations. The manufacturers of these devices, components or peripherals or vendors of the program code find it difficult to provide upgrades and services to each and every user using service outlets.

Today, computers are typically found in homes and offices and are routinely carried by users. Unlike dedicated client devices, computers are general purpose devices that are sold to perform a rather unlimited variety of services through installation and operation of a corresponding variety of application software. Computers often interact with remote servers via Internet for purposes that include upgrading of program code, i.e., software or firmware. This is often done using a communication infrastructure such as Internet connectivity, intranet, cellular, wired or wireless local area network, point-to-point link or combinations thereof. Such program code upgrades may be initiated automatically or may require user interaction with a program in the manufacturer's or software provider's server. For example, upgrading operating system software by providing patches is routinely performed by vendors. Computer and program code manuals are also often available both online and locally on a computer's storage device.

The manufacturers, chipset vendors or software providers of many other dedicated client devices provide periodic attention to these devices in the form of after sale services and upgrading software. These digital devices are progressively gaining versatility and sophistication both in terms of hardware and program codes found in these devices. The problems faced by the manufacturers and users compound as the dedicated client devices become more complex. For example, higher complexity leads to more chances for faulty products being released and sold, higher operating difficulty, greater peripheral availability and need, and higher real or perceived failure rates.

Many of the dedicated client devices such as cell phones or camcorders have small user interface (display, keyboards etc.). Smaller user interface limit the user's ability to interact with the device. For example, the user may find it hard to troubleshoot user interface related problems and may find it hard to communicate this problem to the remote support person.

Further limitations and disadvantages of conventional and traditional approaches will become apparent to one of ordinary skill in the art through comparison of such systems with the present invention.

### BRIEF SUMMARY OF THE INVENTION

Aspect of the present invention is found in dedicated client devices supporting web based service, specifications and interactions. In general, the concept of product support network involves providing service support and program code (software or firmware) upgrade support to the dedicated client devices such as a camcorder or a television, by the dedicated client device manufacturer or a software vendor. The service support, according to the present invention, requires user to log on to the server, via a communication network, and request for services. Similarly program code upgrade requires the dedicated client device to log on to the server and request for the required upgrade.

Both the dedicated client devices and the supporting servers have unique identification addresses, which they use to communicate with each other. Both of providing service support and program code upgrades requires dedicated client device to provide information about current status of the dedicated client device to the supporting server, which is done by way of the device providing one or more of web pages stored in the memory of the device. Further, the service support and program code upgrades may require a battery of tests to be conducted on the dedicated client device or remote operation of the dedicated client device, by the respective service provider, the software routines for which are placed by in the supporting server.

The dedicated client devices may have built-in networking circuitry that facilitates logging on to the supporting server and communicating with the supporting server via a communication network such as an Internet, or the process of logging on to the network and communicating with the supporting server may be facilitated by a local personal computer. In case of a built-in network circuitry, the communication with the supporting server is facilitated by the user input via user interface provided in the dedicated client device. In accordance with the present invention of the product support network, the supporting server may be placed in some remote location, and the user of the dedicated client device can avail the facility of support and service from any place where there is facility to couple with a network such as an Internet and log on to the server.

The product support network consists of a communication network, a supporting server, a dedicated client device, and a computer having a communication network browser. The supporting server is communicatively coupled to the communication network, having a first reference address. The supporting server is capable of delivering stored program code that provides product support functionality and a page of product support information. The dedicated client device has a second reference address, and stores the first reference address. The communication network browser receives and displays, through interaction with the dedicated client device using the second reference address, the page support information and downloads and executes at least a portion of the stored program code. The dedicated client device consists of a storage device, capable of delivering a web page of device related information upon request, via a communication pathway, using web reference addresses. The supporting server's product support functionality is include testing the devices, upgrading program codes in the devices, delivering user manuals and gathering statistics. The communication pathway may be Internet, a wireless network or other.

There are many ways in which the interaction between a dedicated client device and a server can be initiated. For example, the dedicated client device can initiate communication with the server, using the first reference address, being facilitated by a personal computer. Alternatively, the personal computer communicatively coupled to the dedicated client device initiates communication with the device and the server, using the first and second reference addresses and act as an interloper between a dedicated client device and the server. Or, the server communicatively coupled to the dedicated client device, facilitated by a personal computer, initiates communication with the device using second reference address. Another possibility is that of the dedicated client device, upon request, providing reference address to a web site which provides device related information. The dedicated client device may also initiate communication with another dedicated client device when communicatively coupled, using web reference addresses.

In an Internet network coupling a computer and a server that stores a web page and program code, a dedicated client device circuitry consists of a system controller, a memory, a communication interface, an user input device and a display. The dedicated client device is capable of establishing communication and interacting with the server directly, being facilitated by a user input device and a display. The device related web page stored in the memory of dedicated client device includes information related to program code, chip sets, and peripherals.

In a product support network, dedicated client device establishing communication with an interrogating machine (or a requester) includes steps of receiving a request from a requester (such as an external computer, a server or another dedicated client device) for setting up a communication link, establishing a communication with the requester, by employing a communication network, communicating a web page to the requester, authenticating the server database if needed and providing credentials for user authentication. The web page communicated to the requester consists of device related information, chip set related information or program code related information, which reflects current status of the device. The communication with an external requester may take place using an Internet protocol and web reference addresses. Further, the dedicated client device delivers a web address vector, identifying a relevant hypertext transfer protocol path to a server, destined for the network browser.

The upgrading of program code in a dedicated client device include steps of identifying pathway to the server, responding to the requests by the server, initiating delivery of device information to the server, receiving and storing program code in the dedicated client device, testing the dedicated client device if needed and upgrading the program code in the dedicated client device. Further, the testing process itself consists of receiving test code from the server, executing the test code within the dedicated client device, identifying the faulty unit within the device if any, and displaying the results of testing in the local display and the network browser. The pathway to the server is either a direct pathway or personal computer pathway.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1 is a perspective exemplary block diagram illustrating a product support network and underlying operation and interaction between dedicated client devices and the servers via a communication infrastructure to provide support services to users of dedicated client devices in accordance with the present invention;

FIG. 2 is a perspective block diagram of an embodiment of the product support network of FIG. 1 that provides further detail regarding the interconnection and interactions of servers, personal computers and dedicated client devices with direct and/or indirect online connectivity;

FIG. 3 is an exemplary block diagram that shows typical interconnections between a personal computer and dedicated client devices;

FIG. 4 is an exemplary block diagram that shows architecture of a typical dedicated client device according to one embodiment of the present invention;

FIG. 5 is a perspective block diagram illustrating typical program code upgrading and interrogation of dedicated client devices by a server, according to one embodiment of the present invention;

FIG. 6 is a perspective exemplary block diagram illustrating testing and interrogation of a typical dedicated client device by a server, according to one embodiment of the present invention;

FIG. 7 is a schematic block diagram that illustrates necessary hardware modifications required in a typical dedicated client device using an example of a digital camcorder, in accordance with an embodiment of the invention;

FIG. 8 is a flow diagram illustrating the method involved in ownership and upgrading program code in a typical dedicated client device, according to one embodiment of the present invention;

FIG. 9 is a flow chart illustrating typical processes that occurs within the dedicated client device while upgrading program code, according to one embodiment of the present invention;

FIG. 10 is a flow chart illustrating the detailed procedure involved in testing and upgrading program code in a typical dedicated client device, from the device's point of view, in accordance with the present invention; and

FIG. 11 is a flow diagram illustrating the method involved in testing and upgrading program code in a dedicated client device, from the perspective of a facilitating personal computer.

### DETAILED DESCRIPTION OF THE INVENTION

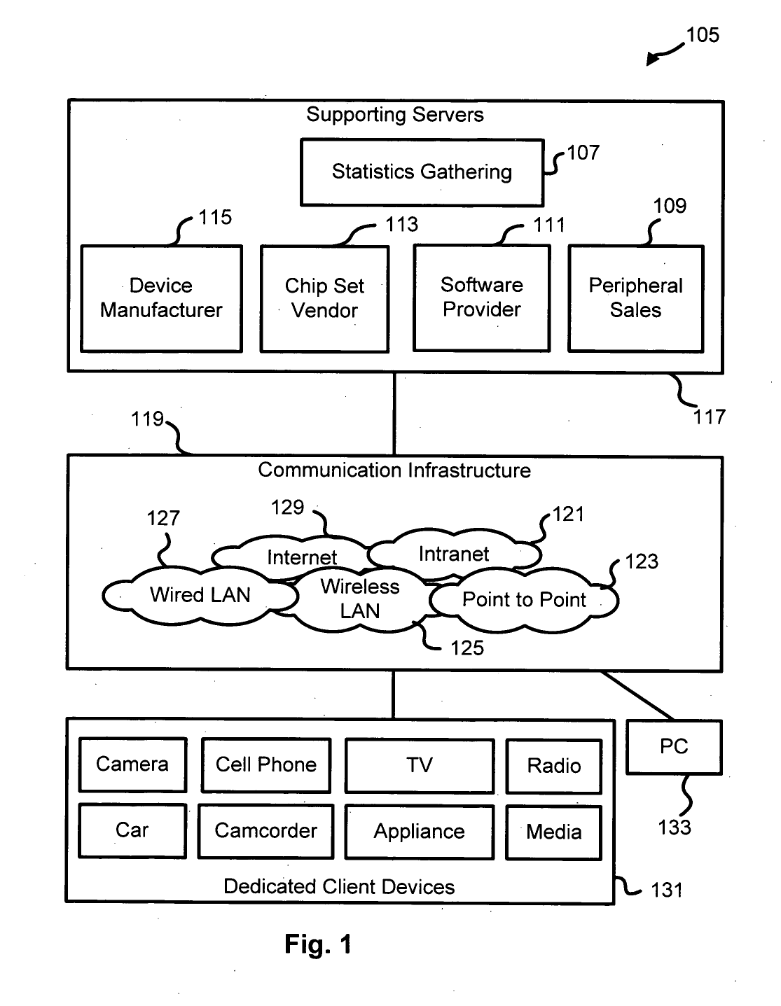

FIG. 1 is a perspective exemplary block diagram illustrating a product support network 105 and underlying operation and interaction between dedicated client devices 131 and servers 117 via a communication infrastructure 119 to provide support services to users of dedicated client devices 131 in accordance with the present invention. The dedicated client devices 131 communicatively couple via a communication infrastructure 119 to supporting servers 117 and a personal computer 133. The communication infrastructure 119 may be any infrastructure supporting wireless and/or wired communication pathways. For example, depending on the embodiment, the communication infrastructure may comprises any one or more of Internet 129, intranet 121, wired local area network (LAN) 127, wireless local area network 125 and point-to-point link 123. The supporting servers 117 typically comprise one or more of statistics gathering servers 107, peripheral and component sales servers 109, software provider's servers 111, chip set vendor's servers 113, and device manufacturer's server 115.

In general, the concept of product support network involves providing service support and program code (software or firmware) upgrade support to the dedicated client device 131, by the dedicated client device manufacturer, seller, or a program code vendor using the remotely placed supporting server 117. The dedicated client device 131 either directly communicates with the remote supporting server 117, for this purpose, or communicates with the remote supporting server 117 using the personal computer 133 placed near the dedicated client device 131. Each of the dedicated client devices 131 and the supporting servers 117 have unique reference addresses which enable them to identify and communicate with each other, once the physical connection is established using the communication infrastructure 119.

In one embodiment, the dedicated client device 131 has web page(s) placed in its memory, containing the information required by the supporting server 117. The dedicated client device 131 is connected by the, via the personal computer 133, to the remote supporting server 117 using the communication infrastructure 119, for the purpose of availing service support (upon identification of a malfunction of the dedicated client device 131) or program code upgrade. The user initiates this process by activating a software provided by the manufacturer or the seller or the vendor of the dedicated client device in the personal computer 133, and then physically connecting the dedicated client device 131 to the personal computer 133 using a USB or other wired/wireless means and logging on to the server and providing required authentication information. The supporting server 117 and the dedicated client device 131 interact there upon in one of the many possible ways, according to a pre-designed routine by the manufacturer, seller, or the vendor. The software in the personal computer 133 offers a plethora of options for services and upgrades that can be launched or initiated via click of a mouse.

The service support and upgrade support by the server 117, of the dedicated client device 131, includes automatic device/peripheral testing and analysis, remote operation of the device, delivering the results, automated repairs or recommendation of possible remedy to the malfunction (such as offering free/charged replacement of devices/components/peripherals, suggesting service center delivery and means), testing, verifying and upgrading program codes (software or firmware). Further, the supporting server 117 may deliver upon request by the user, up-to-date user manuals for the dedicated client device 131 in the form of a computer file (or by other means), either to the personal computer 133 or directly to the device 131. The supporting server 117 may also conduct ongoing and behind the scene testing/statistics gathering and program code upgrades, in automated sequence. Other types of services provided by the supporting server 117 include delivery of advertisements of new peripherals, dedicated client device 131 old age replacement and other related products.

In another embodiment, the user may carry out the above transactions by directly connecting the dedicated client device 131 to the server 117, via a communication infrastructure 119, without being facilitated by the personal computer 133. This requires an in-built communication module inside the dedicated client device 131.

Dedicated client devices 131, the personal computer 133 and the supporting servers 117 interact via the communication infrastructure 119, Internet 129 is a widely used communication network that uses IP (Internet Protocol) and DNS (Domain Name Service). In some embodiments of the present invention, dedicated client devices are adapted to directly and/or indirectly interact with remote support servers via the Internet 129 using Internet standard TCP/IP (Transmission Control Protocol/Internet Protocol) and reference addresses. Dedicated client devices may use any protocols to communicate using any other communication networks such as wireless LAN 125.

The supporting servers 117 bring web based supporting services and specifications to the dedicated client devices 131. The dedicated client devices 131 are capable of providing information to the servers once communication is established. Typical supporting servers that may provide services to dedicated client devices are statistics gathering servers 107, peripheral sales sever 109, software provider's server 111, chip set vendor's server 113 and device manufacturer's server 115. Software provider's server 111 allows program code (software) to be upgraded when the user establishes communication with the server and requests for upgrades. Statistics gathering server 107 is used by the manufacturers of dedicated client devices or chip sets or peripherals to collect statistics that help them improve their products and provide better services.

Networking and communication between the personal computer 133 and the supporting servers 117 using a communication infrastructure 119 may be used in order to provide services such as testing of the computers, hardware and software by the manufacturers, chip set vendors or software providers. The communication infrastructure 119 simultaneously supports all of direct dial-up, ADSL (Asymmetric Digital Subscriber Line), Ethernet, USB, serial or parallel links, cable, cellular, Bluetooth, satellite, WLAN (Wireless Local Area Network) and other wireless and wired network or point-to-point modem. The connection between the personal computer 133 and the dedicated client device 131 also uses any one of the above said communication network tools. The communication between the dedicated client device 131 and the supporting server 117, either directly or via a personal computer 133, takes place using any one of the above mentioned communication tools and the corresponding protocols. The dedicated device 131, by itself, may support any one or multiple sets of or all of the communication tools discussed above.

For example, the dedicated client device 131 may be a high definition digital television interacting with the television manufacturer's server 115 via a communication infrastructure 119 such as Internet 129. The television may interact with the server directly by adapting a network card in the television and connecting television to the Internet network or may happen indirectly by tethering the television to a personal computer, the personal computer being connected to an Internet network.

Dedicated client devices 131 are typical digital devices in everyday use at home and offices such as cameras, cell phones, high definition digital televisions, radios, cars with embedded digital electronic functionality, camcorder, digital toys, video games, appliances, and media. Examples of media players include tape and VHS (Video Home System) players, CD (Compact Disk) players, VCD (Video Compact Disk) players, MP3 (Moving Picture Experts Group—Audio Layer 3) players, DVD (Digital Video Disk) players and other mono, stereo and surround sound audio equipments. Both media players and appliances are among typical dedicated client devices and have digital processing circuitry and memory. Some of the examples of household appliances commonly in use are refrigerators, washing machines, ovens, and air conditioners.

For example, the device manufacturer's server 115 and the chip set vendor's server 113 may provide services such as automated testing of one of the dedicated client devices 131 or the underlying chip sets, upgrading firmware, providing access to manuals and user guides, or remotely operating the device. Similarly, peripheral sales server 109 provides services and specifications to the peripherals of these dedicated client devices. For the purpose of testing, an interrogating device, i.e., one of the manufacturer's server, a software vendor's server, a peripheral sales server or simply a personal computer) may remotely operate the device, going through all possible operation cycles, troubleshooting the device problems and informing the user about the trouble spots.

In one embodiment, for the purpose of logging in and authenticating with the server, either via a personal computer 133 or directly, the user types in the unique IP (Internet Protocol) address (or any other reference address if the communication protocol used is not that of an Internet) of the dedicated client device 131 into the personal computer's 133 web browser or into the dedicated client device's 131 interface upon request by the server 117. The same process of logging in and authentication also applies if the user of the dedicated client device 131 initiates the communication with server 117, via the dedicated client device's 131 user interface. Subsequent web pages or functionality offered on the first web page may also be delivered or executed from the dedicated client device 131 or the supporting server 117 or the personal computer 133. The dedicated client device's 131 IP address may be printed on the dedicated client device's 131 model/manufacturer's tag or may be displayed on the dedicated client device screen in response to the user's request. The dedicated client device manual can also contain reference address. Alternatively, the reference address provided on or via the dedicated client device display may merely be an address of a servicing server 117. Further, the IP address (or reference address) of the supporting server 117 might be provided in a similar way. For example, the dedicated client device's 131 user interface may have a button (and via a display) meant to establish communication with one of the remote supporting servers 117 automatically using the reference address of the dedicated client device 131 itself and that of the remote supporting server 117. The dedicated client device 131 may provide options to change the reference address of the remote supporting server 117 (by simply typing in the new address), if the user wants to log on to a different supporting server 117.

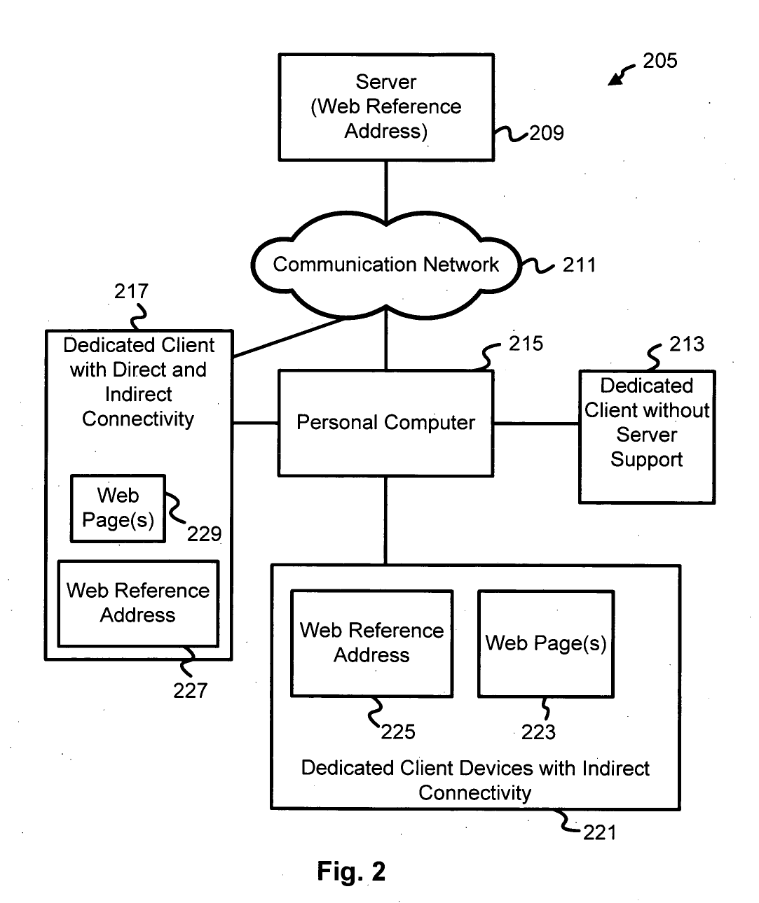

FIG. 2 is a perspective block diagram 205 illustrating interactions between dedicated client devices with direct or indirect online connectivity and servers via a personal computer and a communication network, in accordance with the present invention. The FIG. 2 shown is an embodiment of a portion of the product support network shown in FIG. 1. The system comprises of dedicated client devices with indirect online connectivity 221 and dedicated client devices with both direct and indirect online connectivity 217 communicatively coupled with the server 209 using a personal computer 215 via a communication network 211. Further, the system comprises of dedicated client devices without server support 213 interacting only with personal computer 215, but not with the server 209.

In an embodiment according to the present invention, the dedicated client devices with both direct and indirect online connectivity 217 contain web reference address 227 and web page(s) 229. The web reference address 227 provides information about address of the device connected to the network, for the purpose of establishing communication with the server 209. The dedicated client device also stores reference addresses of the relevant servers. The web page(s) 229 contains a home page which provides much information about the device, peripherals, and the program code it contains. Further, web page(s) 229 may contain additional pages with more information about the device, depending on the type and complexity of the dedicated client device 217. The dedicated client device 217 is adapted to deliver web page(s) direct from the memory of the underlying device. For example, web page upgrades are delivered in background when requested by a personal computer 215 or a server 209, or upon manual request via Internet addressable dedicated client device 217.

The dedicated client devices 217, 221 initiate communication with an external interrogating machine such as a personal computer 215, a server 209 or another dedicated client device in one of many ways 213, 217, 221. Firstly, the dedicated client device 217, 221 may initiate communication with the server 209, using the web reference address 227, 225, being facilitated by a personal computer 215. Secondly, the personal computer 215 communicatively coupled to the dedicated client device 217, 221 may initiate communication with the device 217, 221 and the server 209, using the reference addresses 227, 225 stored in the device and act as an interloper between a dedicated client device 217, 221 and the server 209. Thirdly, the server 209 communicatively coupled to the dedicated client device 217, 221, facilitated by a personal computer 215, may initiate communication with the device 217, 221 using reference address 227, 225. Another possibility is that of the dedicated client device 217, 221, upon request, providing reference address (not shown in FIG. 2) to a web site in the Internet which provides device related information.

The dedicated client device with direct and indirect online connectivity 217 can either interact directly with a support server 209 using network 211, or interact with server 209 via a personal computer 215, or just interact with the personal computer 215 without server support when both the personal computer 215 and the dedicated client device 217 are offline. Even though the dedicated client device 217 is capable of directly interacting with the server 209 using network 211, the interaction facilitated by a personal computer 215 may improve usability. On the contrary, if a personal computer 215 is not available, the dedicated client device 217 may directly interact with the server 209.

When both personal computer 209 and dedicated client device 217 are offline (server 209 is neither directly or indirectly available), the client device 217 begins by delivering a sequence of web pages to the personal computer 215 and the dedicated client device 217 might not be able to serve more. If the dedicated client device 217 is using the facility of personal computer 215 to connect to the server 209, in response to the personal computer's 215 web browser request, dedicated client device 217 utilizes a locally stored server vector to either retrieve the web page 223 and forward to the personal computer's 215 web browser or send the vector to the personal computer's 215 web browser as a redirect for the personal computer's 215 direct interaction with the server 209 to get the web page 223. When the dedicated client device is directly connected to the server 209 using network 211, the sever 209 uses address vector(s) of the dedicated client device 217 to identify and interact with the device and in response to the server's 209 request for the web page(s), the dedicated client device responds by providing web page(s). As an alternative, the dedicated client devices 217 may not deliver the actual web page, but instead act as a proxy vector to an Internet based server that will deliver a current web page (or multiple pages) directly or via the dedicated client device to the interrogating device (a personal computer 215 or a server 209). When both dedicated client device 217 and the personal computer 215 are online, by default the personal computer 215 takes over the charge of facilitating interaction with the server 209, though this situation may not arise in everyday usage.

The dedicated client device with indirect online connectivity 221 also contain web reference address 225 and web page(s) 223, with similar functionality as in the case of dedicated client devices with direct and indirect online connectivity 217. The dedicated client device with indirect online connectivity 221 interacts with the server 209 via a communication network 211 using a personal computer 215. The personal computer is connected to the server 209 via a communication network 211 and when the server requests for web reference address 225 or web page(s) 223, the personal computer 215 facilitates in providing these information to the server by interacting with the dedicated client device 221. That is, in response to the personal computer's 215 web browser request, dedicated client device 221 uses a locally stored server vector to either retrieve the web page 223 and forward to the personal computer's 215 web browser or send the vector to the personal computer's 215 web browser as a redirect for the personal computer's 215 direct interaction with the server 209 to get the web page 223; this case is similar to that of dedicated client device 217 when interacting via a personal computer 215 with the server 209. As an alternative, as is the case with dedicated client device 217 when interacting via a personal computer, the dedicated client devices 221 need not necessarily deliver the actual web page, but instead act as a proxy vector to an Internet based server that will deliver a current web page (or multiple pages) directly or via the dedicated client device to the interrogating device (a personal computer 215 or a server 209).

The dedicated client devices without server support 213 only interact with personal computer 215 and are not capable of interacting with the server 209. Therefore, in case of dedicated client devices without server support 213, the server can not provide any service as in the case of dedicated client devices with server support 217, 221. However, in this case, the personal computer 215 interacts with server 209 via a communication network 211 and downloads relevant testing routines and software/firmware upgrades and provides service by this way. That means, in response to a personal computer's 215 web browser request, the dedicated client device 213 can deliver a web page offering functionality only supported by that dedicated client device without any server 209 support.

The communication network 211 allows the dedicated client devices 217, 221 to be interrogated and tested and allows support server 209 located remotely to provide services. The communication network may be any one or more of Internet, intranet, wired LAN, wireless LAN or point-to-point link.

The remote support server 209 is adapted to interrogate and test dedicated client devices 217, 221 and provide software/hardware services. The testing of dedicated client device 217, 221 by remote support server 209 allows server 209 to identify the hardware and program code condition of the device and makes it possible to provide automated or manual repair services or provide recommendations to the user regarding possible replacements of the spares, their availability or upgrading the program code.

In an embodiment, the server 209, via a communication network 211, requests for a web page (or web pages) from a dedicated client device 217, 221. The dedicated client device responds by delivering or assisting in delivering web page(s) (a home page and other linked pages if any) 223, 229 that provides service information such as automated/manual testing procedures, firmware downloads and telephone/fax/address information; specifications such as manuals, user guides, operating guides; interaction interface for the purpose of direct remote operation of the underlying dedicated client device; sales information such for the purpose of upgrades and peripherals; other services such as sales warranty and support and registration and authentication support. Multiple web pages belonging to a dedicated client device 217, 221 may be accessible, by a server 209, either directly or via hyperlinks from the home page.

The registration support by server 209 allows user to register the device after purchase and allows the user to be the owner of the device. Authentication allows the server 209 to confirm the ownership of dedicated client device by a user. Both registration and authentication are essential for the warranty and other service support as well as for gathering statistics about the sales.

In accordance with an embodiment of the present invention, dedicated client devices 217, 221 have digital processing units and memory and are adapted to possess and provide web reference address 225, 227/web page(s) 223, 229 upon request to another device such as a personal computer 215 or a remote support server 209. For example, a dedicated client device 217, 221, 213 may be a handheld recreational video gaming device and the internal circuitry typically contains digital processing circuitry and memory.

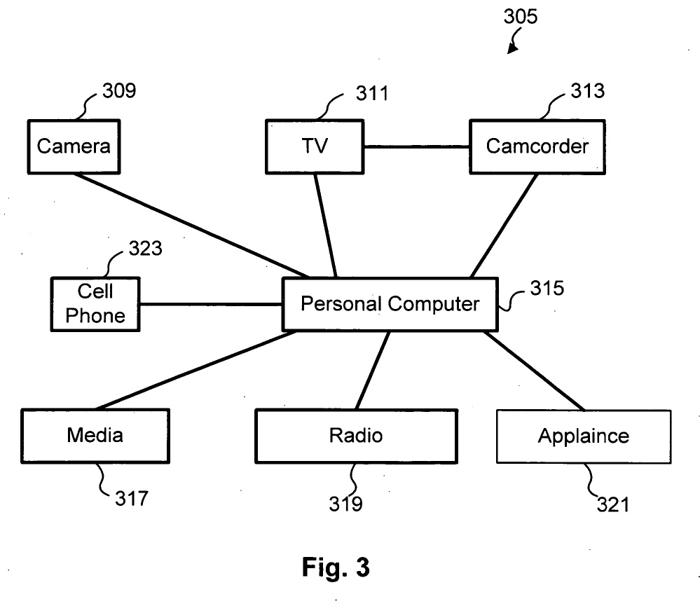

FIG. 3 is an exemplary block diagram 305 that shows typical interconnections between a personal computer and dedicated client devices. Typical dedicated client devices are shown in FIG. 3 such as camera 309, television 311, camcorder 313, media 317, radio 319, appliance 321 and cell phone 323, among others. These devices transfer audio, video data and other digital content between each other and share data for the purposes such as publishing audio, video and still images in personal and professional web sites.

These dedicated client devices generally interact between each other and with a personal computer 315 for uses such as file transfer and photo display. The example shown in FIG. 3 is that of a digital camcorder 313, television 311 and a personal computer 315 interacting between each other. Dedicated client devices such as digital cameras 309 and camcorders 311 empower users to capture, view, edit, save and send images, video and audio files in MPEG (moving picture experts group) or JPEG (joint photographic experts group) format or any other format. These digital cameras 309 and digital camcorders 311 transfer data to a personal computer 315 and user may view, edit, save and send images using software packages and other facilitating technologies. For example, through digital camcorders 313 and personal computer 315 interaction it is possible to send v-mails (video e-mails, similar to e-mails) and are becoming popular. Further, it is possible to view the pictures or moving pictures captured in digital cameras 309 or camcorders 311 in television 311.

Other examples of dedicated client devices exchanging files and data are that of downloading MP3 audio content to a personal computer and transferring these file to a handheld media 317 player such as a MP3 player, or that of uploading contact lists from a personal computer 315 to a cell phone 323. Similarly, the audio content Internet radio stations, which are downloaded into a personal computer 315, can be listened to, via a Bluetooth wireless connection, in surround sound audio players 317. Similarly appliances 321 such as a refrigerator are connected wirelessly to a personal computer so that orders for refills may be placed via Internet to a nearest shop. The same interface with the personal computer 315 can be used for testing and upgrading of program code in the dedicated device such as a refrigerator 321.

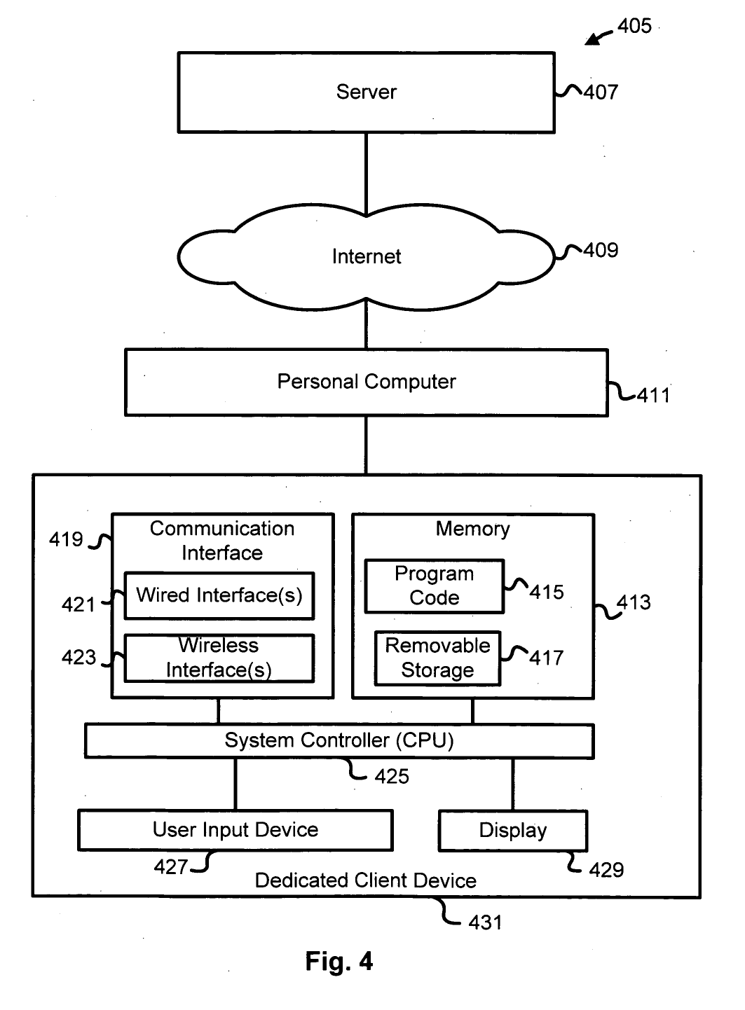

FIG. 4 is an exemplary block diagram 405 that shows architecture of a typical dedicated client device according to one embodiment of the present invention. It comprises of a dedicated client device 431 communicatively coupled to a server 409 using an exemplary communication network such as an Internet 409, via a personal computer 411. In one embodiment, the dedicated client device shown in FIG. 4 itself comprises of a system controller or a CPU (central processing unit) 425, a user input device 427, a display 429, a communication interface 419 and a memory unit 413. The communication interface comprise of wired interface(s) 421 and wireless interface(s) 423. The memory unit comprises program code 415 and a removable storage 417. The dedicated client device 431 is tethered to a personal computer using a cable and a USB (universal serial bus) connector or a wireless link.

In one embodiment according to the present invention, the system controller 425 of the dedicated client device is a general purpose microprocessor. In others, a special purpose microcontroller or high performance RISC (reduced instruction set computer) microprocessor is used. The system controller 425 is capable of managing memory 413, user input device 427, display 429 as well as the communication interface 419. The system controller 425 itself contains or is associated with a memory controller in order to manage memory.

The user input device 427 is either a key pad or a touch screen user interface which facilitates user to input the device with relevant instructions. The display 429 is typically a LCD (liquid crystal display) that allows user to interact with the device. The user input device 427 and display 429 allow user to link dedicated client device 431 to a personal computer 411 and via Internet network 409 to a server 407, and establish communication and facilitate support and services from a remote server.

The communication interface 419 of a dedicated client device 427 consists of wireless interface(s) 423 which in turn made up of a Bluetooth (or other wireless standard) chipset. The unit 423 allows the device 431 to be interfaced with an external device such as a personal computer 411 for the purpose of transmitting and receiving data wirelessly. Similarly, the wired interface(s) 421 allows the dedicated device to be interfaced with an external device using a cable and USB connectors.

The memory 413 is managed by the memory controller (not shown in Figure) which is part of a system controller. The memory 413 consists of ROM (read only memory)/flash memory/DRAM (dynamic random access memory)/SRAM (static random access memory). Both DRAM and SRAM are faster memories and are used in connection with the system controller 425 such as a microprocessor, in a dedicated client device 431. A flash memory is a solid-state, nonvolatile, rewritable memory and is durable, operates at low voltages, and retains data when power is off and is commonly used as a main memory source in most dedicated client devices 431. DRAM and SRAM are faster memories and are used together with the system controller 425 such as a microprocessor. The removable storage 417 also comprises of a non-volatile memory. The memory unit contains firmware 415, which is nothing but low level software, which drives the CPU 425 and controls the hardware of the dedicated client device 431.

For example, the memory 413 and removable storage 417 may be a flash memory unit and are used in dedicated client devices such as digital cameras, cell phones, camcorders, media players and appliances.

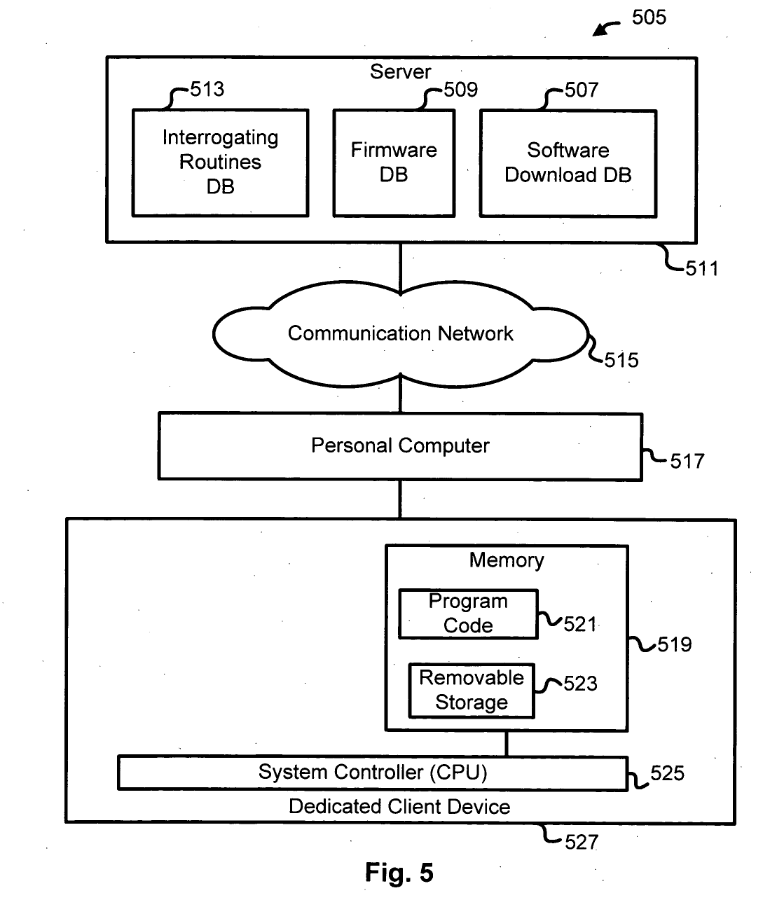

FIG. 5 is a perspective block diagram 505 illustrating typical firmware and software upgrading and interrogation of dedicated client devices by a server, according to one embodiment of the present invention. It comprises of a server 511 interrogating or upgrading program code in the dedicated client device 527 via a communication network 515 and this process is facilitated by a personal computer 517. The communication network 515 is typically an Internet network, it can also be a LAN (wireless or wired local area network), intranet or a point-to-point link.

The dedicated client device 527 comprises of a memory 519 and a system controller 525, among other units such as user interfaces, communication interfaces (not shown in FIG. 5). The system controller unit 525 is either a microcontroller or a microprocessor and is responsible for managing all the functionality of the dedicated client device 527. The system controller unit 525 also contains memory manager (not shown in FIG. 5). The program code 521 resides inside the memory 519, which is a set of basic instructions for the system controller unit 525 and is responsible for hardware functionality management as well as running other applications. Although other types of memory storage might be used, the firmware part of the program code typically resides in an EEPROM (electrically erasable, programmable, read only memory) or FLASH type of storage in the memory 527. Further, the memory may also contain removable storage unit 523 which is used to extend the memory capacity of the dedicated client device 527.

In one embodiment according to the present invention, the server 511 comprises of an interrogating routines DB (database) 513, a firmware database 509 and software download database 511. The server 511 provides interrogation of the device and program code upgrading to the dedicated client device 527 via a communication network 515 and this process may be facilitated by a personal computer 517 or alternatively the dedicated client device 527 may be directly connected to the communication network. The interrogating routines database 513 provides routines that help the server interrogate the device 527 and identify the device manufacturing, compatibility and functionality related information. The firmware database 509 and the software download database 507 contain latest upgrade patches that the vendors develop.

The vendors of the program code 521 that the memory 523 contains improve their program code over a period of time so as to better manage the device functionality and provide these upgrades to the users of the dedicated client devices 527 periodically. The device 527 is connected to a personal computer 517 using a wireless connection or a using a cable and a USB connector and the personal computer 517 is connected to a server 511 via a communication network 515. The server 511 interrogates the device 527 in order to get the information about manufacturing such as model number, program code version and ownership details such as registration details, ownership confirmation and provides program code patches which is downloaded into the dedicated client device 527 and executed in the device 527 itself. When the downloaded patch is executed, the program code gets automatically upgraded.

For example, the dedicated client device 527 may be a digital camera or a digital camcorder. The user who wishes to upgrade the program code (software or firmware) in the digital camera or a digital camcorder connects the device 527 to a personal computer 517 and establishes communication with the server via a communication network 515 which may be an Internet network. The manufacturer's server 511 authenticates the validity of ownership, warranty, or service provisions and then provides the upgrades to the device. The digital camera or digital camcorder downloads these upgrade patches into its memory 519 and executes them in order to upgrade the program code. This process of upgrading the program code may require user input to the device 527 occasionally.

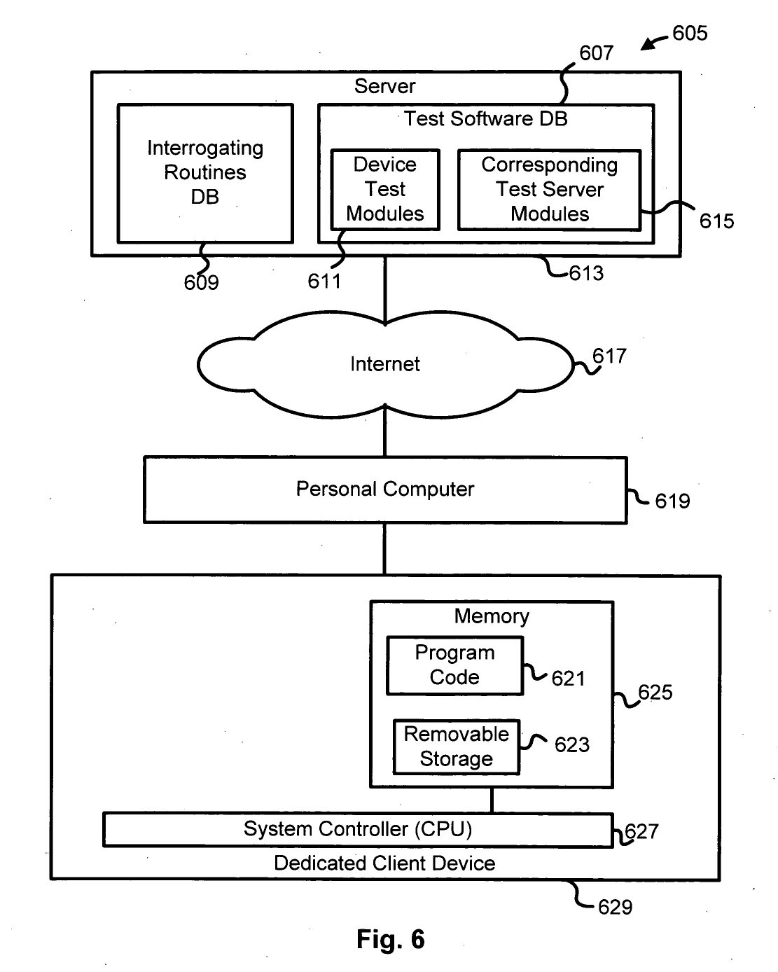

FIG. 6 is a perspective exemplary block diagram 605 illustrating testing and interrogation of a typical dedicated client device by a server, according to one embodiment of the present invention. The system comprises of a server 613, a communication network such as an Internet network 617, a personal computer 619, and a dedicated client device 629.

The dedicated client device 629 comprises of a system controller 627 and a memory unit 625. The system controller 627 manages the entire hardware and the functionality of the device 629 based on the instructions in the firmware part of the program code 621 located in the memory 625. The memory 625 also includes a removable storage 623.

In accordance with an embodiment of the present invention, the server 605 comprises of an interrogating routine DB (database) 609 and a test software database 607. The test software database 607 consists two types of testing modules, they are device test modules 611 and corresponding server test modules 615.

The test software database contains programs required to test the dedicated client device 629 for the purpose of providing online service to the device 613. The device test modules unit 611 sends the testing scripts to the dedicated client device 629 via a personal computer 619. These testing scripts are executed in the device 629 itself and the results, as a part of the testing routine, are sent back to the server 613. The corresponding test server modules unit 615 in the server 613 identifies the results and takes appropriate actions.

As an example, the device 629 may be a digital camera, tested by the software vendor's server 613 in order to identify and fix bugs in the firmware part of the program code 621 contained in the camera. The hardware of the camera may also be tested by the software vendor's server 613 in order to find if the device 629 is compatible with the latest version of the program code that the vendor may provide. Similarly, the digital camera may be tested by the manufacturer's server 613 for the purpose of identifying the hardware problems and fix them if possible or suggest the procedures to be followed in order to get it fixed. The digital camera is either tested directly by connecting it to the server 613 via Internet 617 or the testing is facilitated by a personal computer 619.

There are multiple ways by which testing the digital camera may be conducted. Firstly, the routines contained in the test software database 607 such as a Java code or other browser executable code are downloaded and either compiled or interpreted by the personal computer's 619 browser. Then, the web browser of the personal computer 619 may interact with the digital camera and execute these codes inside the digital camera for the purpose of testing. The results are communicated back to the server 613, either intermittently or at the end of the entire test routine. The executable Java code (or any other browser executable code) may be downloaded to the personal computer 619 in modules with testing tree structure to minimize overall download size. Secondly, if the digital camera is directly connected to the network without the personal computer 619, then the testing codes contained in the test software database 607 can directly be transmitted to the digital camera and executed and the results may be transmitted back to the server 613. In this case, the digital camera should be able to compile (or interpret) and execute the testing codes. Thirdly, the testing software may run on the server 613 itself and the testing commands may be sent over to the digital camera and the results may be communicated back to the server. Further, the dedicated client device could receive some of the testing codes prior to the product (digital camera) release, in which case the code needs to be simply executed upon command from the server 613 or the personal computer 619.

The three options of delivery of codes to the personal computer 619 or the dedicated client device 629 mentioned above are applicable not only to the testing of the device 629 but also to the delivery and operation of the upgrades of program codes (described in FIG. 5), that is, the delivery of software code that controls and installs and recovers the program code upgrades. Similarly, sales related information (web page(s)) of add-ons, replacement dedicated client devices and related devices and supplies may be pushed to the personal computer 619 or further pushed to the dedicated client device's 629 user interface display or audio playback.

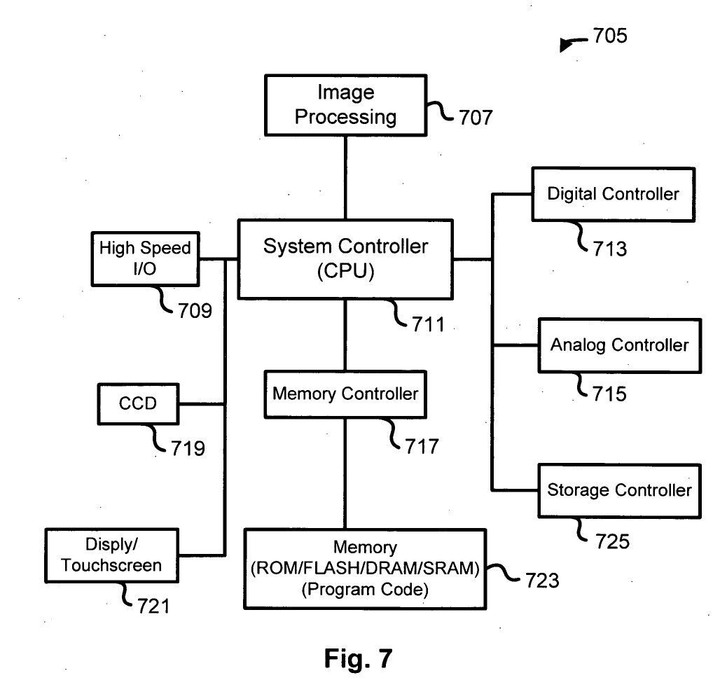

FIG. 7 is a schematic block diagram 705 that illustrates necessary hardware modifications required in a typical dedicated client device using an example of a digital camcorder, in accordance with an embodiment of the invention. It comprises of a system controller 711, memory controller 717, digital controller 713, analog controller 715, storage controller 725, image processing unit 707, high speed I/O (input/output) unit 709, CCD (charge coupled device) unit 719, display/touchscreen unit 721 and a memory unit (ROM/flash/DRAM/SRAM) unit 723. The memory unit 723 also contains program code.

The functionality of a typical digital camcorder begins with the CCD unit 719 which captures analog image of the object in focus. This image is digitized (analog to digital conversion) in the CCD unit 719 itself. The system controller or CPU 711 typically contains a microcontroller and provides system level interface and management to all of the hardware in the camcorder unit 705. The image processing unit 707 improves the captured digital video signals by way of DSP (digital signal processing) programming. The memory controller 717 provides an interface between system controller 711 and the memory 723 allows various types of memory storage (ROM/flash/DRAM/SRAM) to be accessed systematically. The memory unit 723 is made up of many different types of memory devices such as ROM, flash, DRAM and SRAM and holds firmware and system application software. Storage controller 725 provides access to variety of external storage devices such as a CD drive or a memory card. The analog controller 715 converts digital video signals stored in memory 723 to analog and makes it possible to be displayed in standard CRT (cathode ray tube) type of displays such as the one in a television. The digital controller 713 allows the digital signals to be displayed in the LCD (liquid crystal display) display 721. High speed I/O allows digital video signal, either from CCD 719 or from memory 723, to be sent and received via a USB connector or any other type of standard connector.

In accordance with an embodiment of the present invention, a dedicated client device such as a digital camcorder, upon request by an external device, retrieves web page(s) from the memory 723 and sends it out through high speed I/O unit 709. Further, each sub unit (chip sets) with in the camcorder 705, such as CCD unit 719, display/touchscreen unit 721 and controllers 713, 715, 717, 725 have their manufacturing related information and other information available in the form of web page(s), which are also provided to an external device on request. Interrogation and testing of the digital camcorder requires routines or scripts to be stored in memory 723 and executed when requested by a remote server. The device itself is identified in a network on the basis of a web reference address.

All these processes are managed mainly by system controller 711 and high speed I/O 709. Therefore, the system controller 711 used is a versatile microcontroller (or a microprocessor) capable of handling all of the above operations. The high speed I/O unit 709 also includes a network card (not shown in FIG. 7) which allows the camcorder to interact with a remote support server via a communication network such as an Internet. The network card also allows the entire process to be facilitated by a personal computer, which improves usability. Further, the display/touch screen unit 721 allow user to initiate communication with the remote server and control the entire process such as providing authentication details to the server; thus supporting the user interaction while the server provides service. The system controller 711 is capable of storing testing codes received from a interrogating machine, and execute it within the device and send a report to the interrogating machine.

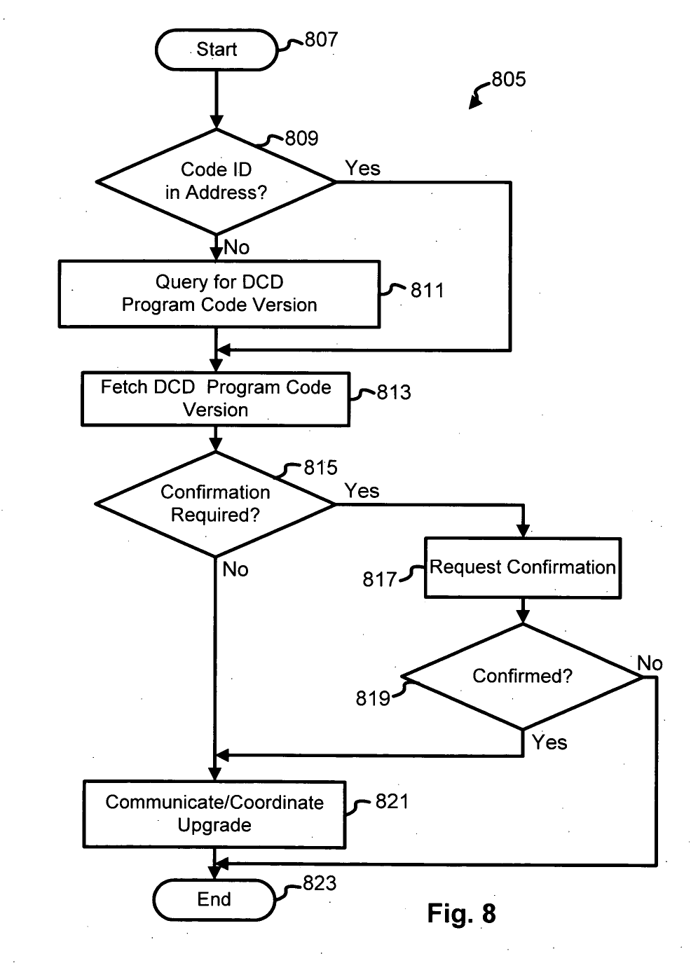

FIG. 8 is a flow diagram 805 illustrating the method involved in ownership and up-grading of program code in a typical dedicated client device, according to one embodiment of the present invention. The general process of authentication and upgrading of program code (firmware or software) in a dedicated client device begins at block 807 when a communication link is established between the server and the dedicated client device using respective web reference addresses. The establishment of communication link is initiated by the user, when the user connects the device to a communication network. The web reference addresses may contain firmware ID which allows the server to determine the version and other information related to the firmware. Similarly, the web reference addresses may contain software ID as well. The web reference addresses may further contain model number and other details related to the dedicated client device.

Then, at a next decision block 809, the server determines if firmware ID (identifier) is available within the web reference addresses. If the server determines that the web reference address do not contain firmware ID, at next block 811, it queries for dedicated client device firmware/software version and after acquiring firmware ID, it jumps to the next block 813. If, on the other hand, the web address vector(s) contain firmware ID, the server directly jumps to block 813 without querying for program code version. At the next block 813, the server fetches program code version.

Then, at a next decision block 815, the server decides if confirmation or authentication is required, based on the user registration at the time of purchase or manufacturer's or software vendor's policies regarding sale of dedicated client device. If it is determined that the confirmation is required, at next block 817, the server requests user for confirmation details. Then, at next decision block 819, the server determines if confirmation is successful. If confirmation is not successful at block 819, the server sends appropriate messages to the dedicated client device and ends the process at block 823.

If, at the decision block 815 the server determines that the confirmation is not required, or at the decision block 819 the server determines that confirmation is successful, the server proceeds further to block 821, and coordinates the upgrading of program code and communicates appropriate messages to the dedicated client device. Then, this process of authentication and upgrading ends at block 823.

For example, the general process of upgrading may be that of a camcorder program code (firmware or software). The same process may be applied to downloading of other dedicated client device related information. The initiation of authentication and upgrading process may be done either directly from a dedicated client device or from a personal computer interaction, either manually or automatically and this process may occur on need basis/periodically/upon detection of a problem in the device program code.

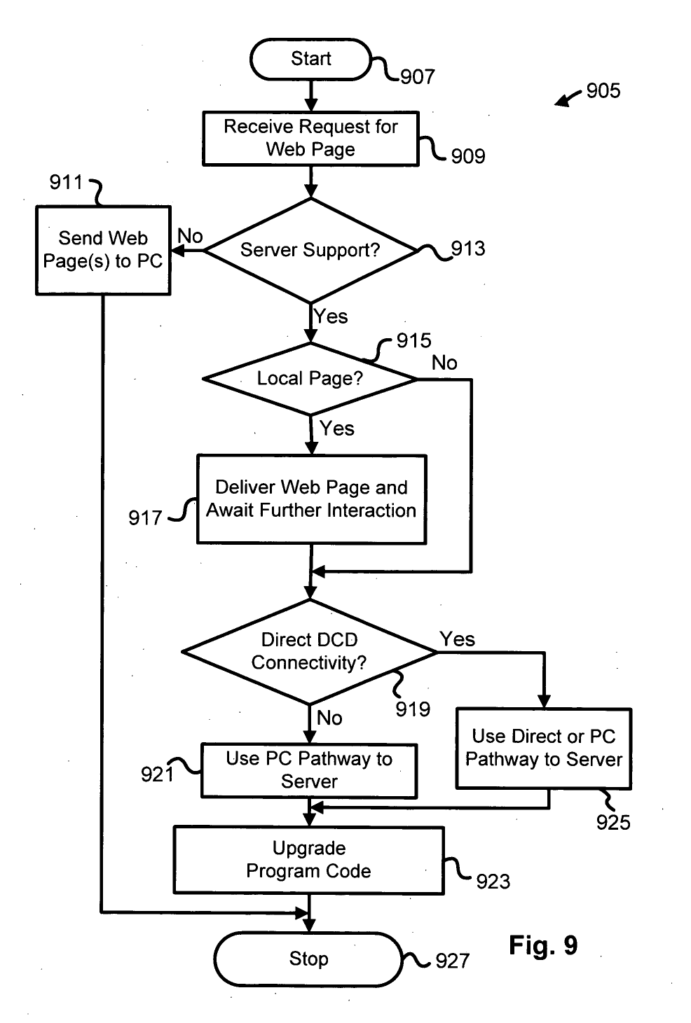

FIG. 9 is a flow chart 905 illustrating typical processes that occurs within the dedicated client device while upgrading program code, according to one embodiment of the present invention. The process of dedicated client device upgrading begins at the start block 907 when the communication link is initiated and established, with the server. Then, at the next block 909, the dedicated client device receives request for a web page from the server, either directly by being linked to the communication network such as an Internet or by being facilitated by a personal computer which is online.

Then at a next decision block 913, the dedicated client device determines on the online support within the device. If it is determined that there is no online support, the device sends web page(s) to the personal computer at the block 911 and ends the process at stop block 927. On the other hand at the decision block 913, if it is determined that there is online support, at the next decision block 915, the device determines if the web page provided is a local page. Alternatively, the dedicated client device may provide a link to a web site which in turn provides the web pages (not shown in FIG. 9). If it is determined that the web page requested by the server is a local page at decision block 915, then the dedicated client device delivers web page and waits for further interaction from the server at block 917. If the request by the server is not for a local page at block 915 or after delivering web page at block 917, at the next decision block 919 the dedicated client device determines if the online connectivity is direct or not.

Then, if it is determined at the decision block 919 that the device is capable of direct online connectivity, at the next block 925, the dedicated client device either uses direct pathway or the PC pathway to further the process of upgrading. If on the other hand it is determined at block 919 that there is no direct online connectivity, the dedicated client device uses the PC pathway to the server at block 921. Then, at the next block 923, the server upgrades the software/firmware in the dedicated client device. The process ends at the next block 927.

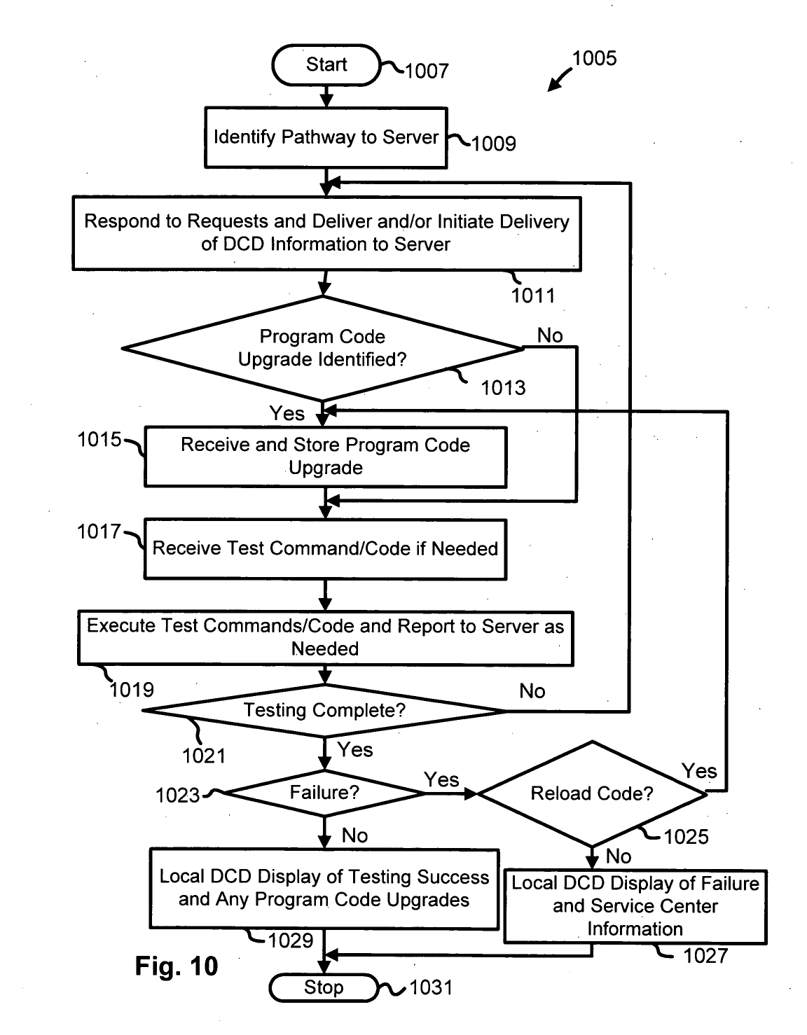

FIG. 10 is a flow chart 1005 illustrating the detailed procedure involved in testing and upgrading of program code in a typical dedicated client device, from the device's point of view, in accordance with the present invention. The procedure begins at the start block 1007 after the initial steps of establishing connection with server and sending web page(s) requested by the server, as illustrated in FIG. 9 before upgrading the program code. The dedicated client device identifies a pathway to the server at the next block 1009, the pathway may be direct or may be via a personal computer. At the next block 1011, the dedicated client device, upon sending an upgrade request to the server, responds to the requests of the server and delivers and/or initiates delivery of device information, such as program code version and device model number, to the server.

Then, at the next decision block 1013, the dedicated client device determines if there is a need to upgrade program code. If the program code upgrade is identified at the block 1013, then the dedicated client device receives and stores program code patch at block 1015; and if not, the device skips the step of block 1015. Next, at the block 1017, the dedicated client device receives and stores test command/code if needed. The testing may be initiated based on the device interaction with the personal computer or with the server, or may be initiated by the user upon detection of a malfunction. At the next block 1019, the dedicated client device executes test commands/code at the device itself and sends a report to the server as needed.

Then, at the next decision block 1021, the device determines if the testing is complete. If it is determined that the testing is not complete, it will respond to the requests to deliver device information again and follows steps from block 1011 again. If at the decision block 1021 the testing is complete, the device again takes a decision on whether the testing is successful or not, at the next decision blocks 1023. If the testing is a success at the block 1023, the device displays appropriate message in the local device display of the testing success and any program code upgrades, at the next block 1029 and ends the procedure at the next block 1031.

If at the decision block 1023, it is determined that the testing is a failure, at the next decision block 1025, the device determines if there is a need for reloading the firmware/software. The reloading of program code may happen based on the device determination or the user input to the device, at the block 1025. If it is decided that reloading is necessary at the block 1025, then the device again receives and stores program code and repeats steps after the block 1015. If at the decision block 1025, it is determined that there is no need to reload the program code, then the device locally displays the failure of the service and the service center information and ends the procedure at the next block 1031.

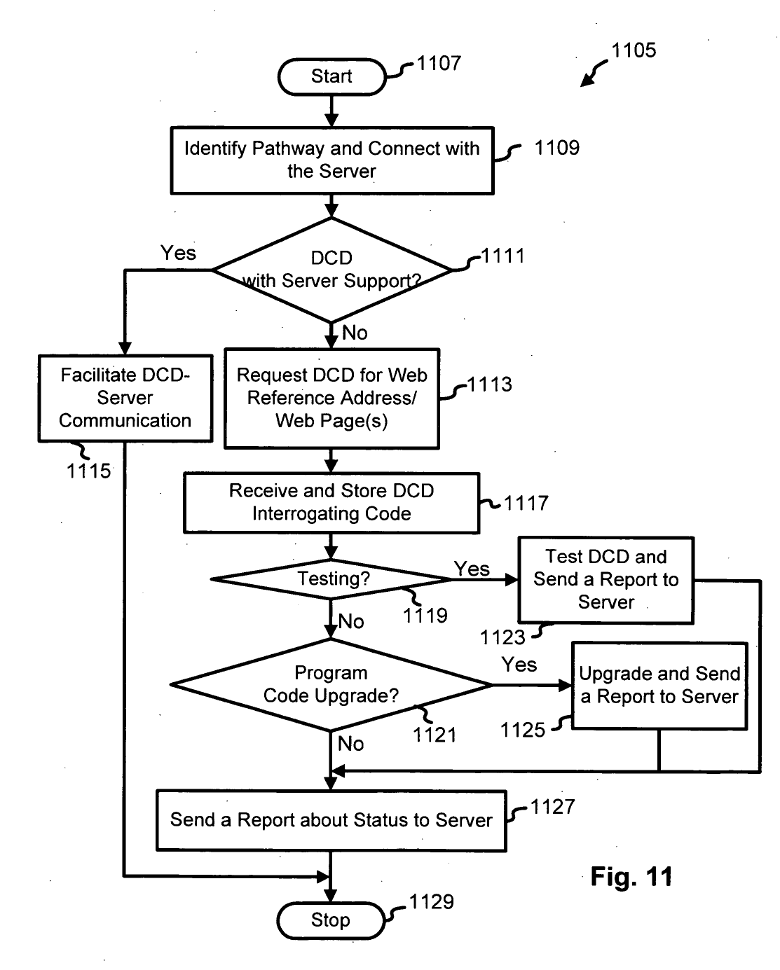

FIG. 11 is a flow diagram 1105 illustrating the method involved in testing and upgrading of program code in a dedicated client device, from the perspective of a facilitating personal computer. The process begins at block 1107, when the user connects the dedicated client device to the personal computer which is online. The personal computer identifies the pathway and connects with the server at the next block 1109.

Then, at the next decision block 1111, the personal computer determines if there is online server support to the device. If it is determined that there is online server support to the device at block 1111, then at the next block 1115, the personal computer facilitates dedicated client device-server communication. The process ends at the next block 1129.

If at the decision block 1111, it is determined that there is no server support, then the personal computer requests device for web address vector(s)/web page(s) at the next block 1113. Then, at the next block 1117, the personal computer requests and receives and stores device interrogating (or testing) codes/commands. Then, at the next decision block 1119 it is determined if testing of the device is necessary. The determination at block 1119 may occur if the user requests for testing of the device or if the server requests for testing of the device. If it is determined that testing is necessary at the block 1119, then at the next block 1123, the personal computer sends appropriate testing codes to the device, the device executes these codes and the result is sent back to the personal computer. The personal computer sends a report based on the testing results to the server at the block 1123.

If testing is not required at the block 1119, then at the next decision block 1121, it is determined if program code upgrading is necessary. If it is determined that program code upgrading is not necessary at block 1127, then the personal computer sends a report to the server about the status of the testing and upgrading at the next block 1127. The personal computer ends the process at the next step 1129.

If it is determined that there is need for firmware/software upgrading at block 1121, then at the next block 1125, personal computer assists in upgrading of the program code and sends a report to the server about the status of the upgrading. Then, at the next block 1127, the personal computer sends a final report on the entire process and ends the procedure at the next block 1129.

The present invention relates generally to a DCD (dedicated client device). Although the previous detailed description discusses aspects of the invention in terms of DCDs such as a camera, cell phone, television, radio, cars, camcorder, household appliance and media equipment, it should be clear that the following also applies to other situations, such as digital toys, video games or any other prospective DCDs with electronic functionality.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A product support network comprising:
a communication network;
a server, communicatively coupled to the communication network, having a first reference address; the server being capable of delivering stored program code that provides product support functionality and a page of product support information;
a dedicated client device, having a second reference address, that stores the first reference address;
a computer having a communication network browser; and
through interaction with the dedicated client device using the second reference address, the communication network browser receives and displays the page of product support information and receives and executes at least a portion of the stored program code.

2. The product support network of claim 1, further comprising a communication pathway between the computer and the dedicated client device, the computer receiving the first reference address from the dedicated client device via the communication pathway.

3. The product support network of claim 2, wherein the communication pathway uses an Internet Protocol.

4. The product support network of claim 2, wherein the communication pathway comprises a wireless pathway.

5. The product support network of claim 1, wherein the dedicated client device uses the first reference address to initiate communication with the server.

6. The product support network of claim 1, wherein the computer communicates with the dedicated client device and the server using the first and second reference addresses respectively.

7. The product support network of claim 1, wherein the server initiates communication with the dedicated client device using the second reference address.

8. The product support network of claim 1, wherein the dedicated client device initiates communication with another dedicated client device using a third reference address when communicatively coupled thereto.

9. The product support network of claim 1, wherein at least one of the reference addresses requires domain name server access.

10. The product support network of claim 1, wherein, upon execution, the stored program code tests the functionality of the dedicated client device.

11. The product support network of claim 1, wherein, upon execution, the stored program code manages software upgrades of the dedicated client device.

12. The product support network of claim 1, wherein the page of product support information comprises links for accessing further information.

13. The product support network of claim 12, wherein the further information comprises manuals related to the dedicated client device.

14. The product support network of claim 12, wherein the further information comprises sales information.

15. In a product support network having a communication network attached to both a computer having a web browser and a server that stores a first web page, dedicated client device circuitry comprising:
a system controller that provides system level control;
a memory that stores a second web page containing device related data;
a communication interface, having an first reference address, that communicatively couples with the computer via the web browser and the first reference address; and
a user interface.

16. The dedicated client device circuitry of claim 15, wherein the memory also stores a second reference address associated with the server, and the communication interface utilizes the second reference address to communicate with the server.

17. The dedicated client device circuitry of claim 15, wherein the device related data comprises program code received from the server.

18. The dedicated client device circuitry of claim 17, wherein the program code comprises a firmware upgrade.

19. The dedicated client device circuitry of claim 15, wherein the device related data comprises testing software.

20. The dedicated client device circuitry of claim 15, wherein the device related data comprises information gathering software.

21. The dedicated client device circuitry of claim 15, wherein the device related data comprises information delivered to the server, and the server uses the information to tailor services associated with the dedicated client device circuitry.

22. A method used by a dedicated client device for establishing communication with a requester in a product support network, the method comprising:
receiving a request from the requester for setting up a communication link;
establishing a communication with the requester, by employing a communication network;
communicating a web page to the requester;
authenticating a server database, if needed; and
providing credentials for user authentication.

23. The method of claim 22, wherein the communicating a web page comprises communicating at least one of dedicated client device related information, chip set related information, and program code related information for authentication.

24. The method of claim 22, wherein the web page comprises information that reflects current status of the dedicated client device.

25. The method of claim 22, wherein establishing the communication comprises sending a request using an Internet protocol and web reference addresses.

26. The method of claim 22, wherein the communicating the web page to the requester also comprises delivering a web address vector, identifying a relevant hypertext transfer protocol path to a server, destined for the network browser.

27. A method of operating a dedicated client device to upgrade its program code, in a product support network, the method comprising:
identifying a communication pathway to the server;
sending an upgrade request to the server;
responding to at least one request received from the server;
initiating delivery of device information to the server;
receiving and storing program code in memory of the dedicated client device;
testing the dedicated client device if needed; and
upgrading the program code in the dedicated client device.

28. The method of claim 27, wherein testing the dedicated client device comprises:
receiving test code from the server;
executing the test code within the dedicated client device;
identifying a faulty unit within the device, if any; and
displaying results of testing in the local display and a communicatively coupled network browser.

29. The method of claim 27, wherein the testing the dedicated client device comprises operating the dedicated client device remotely from a communicatively coupled interrogating device.

30. The method of claim 27, wherein identifying the communication pathway comprises communicating with the server using a direct pathway or personal computer pathway.
